(19) United States
(12) Patent Application Publication
(10) Pub. No.: US 2005/0141529 A1
(43) Pub. Date: Jun. 30, 2005

(54) Communication apparatus and communication system

(75) Inventors: Akira Miyajima, Kanagawa (JP); Tomonori Shino, Kanagawa (JP); Tatsuo Bando, Tokyo (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/995,503

(22) Filed: Nov. 24, 2004

(30) Foreign Application Priority Data
Dec. 26, 2003 (JP) 2003-433358

(51) Int. Cl. H04L 12/56

(52) U.S. Cl. 370/401

(57) ABSTRACT

A communication system includes a communication apparatus having memory, telephone controller, voice processor, network interface, display drive, and key interface. The communication system also includes a door intercom home apparatus, a door intercom with a camera, a TV, a video recorder, and a home gateway. The communication apparatus executes voice communication with the door intercom with camera while TV 4 executes an image display function that is not provided in the communication apparatus.

### BACKGROUND OF THE INVENTION

1. Field of the Invention

The present invention relates to a communication apparatus and communication system that enable a plurality of apparatuses to be mutually connected and to utilize function operations of the apparatuses. The communication apparatus and communication system utilize ENUM functions, stores function information of other apparatuses (in connection with their extension numbers) as an NAPTR record in a home gateway, and enables a communication apparatus (e.g., an IP telephone) to select a function in the NAPTR record, when the communication apparatus makes an inquiry using an extension number.

2. Description of Related Art

In recent years of the rapid IP network service development, various researches have been done around the world, on an ENUM function that enables various applications for communication services (e.g., “IP telephones” including e-mail, telephone call, and Internet telephone call; and “IFAX” including fax and Internet fax) utilizing only a currently used telephone number.

A DNS server having the ENUM function is provided with a table that stores and manages a telephone number and destination information including communication service related to the telephone number (e.g. URI (Uniform Resource Identifier) such as e-mail address, ordinary telephone number, IP telephone number, fax number and IFAX number). For example, upon receiving notifications of an inquiry telephone number from a terminal apparatus, destination information corresponding to the inquiry telephone number is obtained from a table. Then, destination (related to communication services) corresponding to the terminal apparatus is selected from the obtained destination information and provided to the terminal apparatus (cf., non-patent article 1).

In a management table within a DNS server, a telephone number and various destination information corresponding to the telephone number (URI information) is usually pre-registered under a permission of a person having the telephone number.

For example, when sending an e-mail from a terminal apparatus to a communication destination, the user of the terminal apparatus inputs the destination telephone number in an e-mail destination field of the e-mail application, while maintaining the e-mail application of the terminal apparatus, and executes a transmission command of the e-mail.

The DNS server, upon receiving the telephone number and the transmission command from the terminal apparatus, searches the management table for an e-mail address corresponding to the telephone number and returns the obtained e-mail address of the destination to the terminal apparatus. Upon receiving the e-mail address of the destination from the DNS server, the user of the terminal apparatus can transmit e-mail to the destination using the e-mail address.

The ENUM function also enables registration of an NAPTR (Naming Authority Pointer) record for each function of IP device. Therefore, when a telephone number is looked up in the ENUM, all functions related to the IP device having the telephone number is displayed in such an NAPTR record.

It is also considered to utilize such ENUM function for communications between communication apparatuses at home or communication apparatuses that are connected to an IP network.

This is because, by employing the existing technology, when it is necessary to transmit a document (e.g., map) via facsimile during voice communication using IP telephones (in order to facilitate the understanding of the information), for example, the caller (or the receiver) needs to make the connection of IFAX machines and transmit the document, after which the voice communication resumes to discuss the document.

In addition, when there is an incoming call from the door intercom with a camera (located for home), the call can be answered using a door intercom located in the living room (having a handset and image viewing monitor), and the face and the appearance of the visitor can be checked while having voice communication with the visitor. However, when answering the call using the IP telephone located in the second floor bedroom, for example, only the voice communication can be performed since the IP telephone is not equipped with the image display function.

[Non-patent article 1] Shigeki GOTO et al., “Internet telephone and ENUM” [on-line], Oct. 18, 2002, Japan Network Information Center, [searched on Nov. 25, 2003], Internet <URL: HYPERLINK http://www.nic.ad.jp/ja/materials/after/20021018/ENUM20021018.PDF>.

When transmitting a document (e.g., a map) via IFAX during a telephone conversation using IP telephones, the conversation needs to be temporarily halted for a series of operations required for the IFAX transmission, which is inconvenient and burdensome for the users.

In addition, when using an IP telephone to answer a call from a door intercom with a camera, the voice and the message of the visitor can be heard. However, the face of the visitor cannot be visually confirmed when the visitor is visiting at night in the dark. Therefore, hanging up the telephone call can be rude to the other party or may be a nuisance to the person opening the door only to find out that the visitor is unsolicited.

### SUMMARY OF THE INVENTION

The present invention addresses the above-described problem. The purpose of the invention is to provide a convenient communication apparatus and communication system that enable another apparatus to execute a function that cannot be done only by the communication apparatus.

In order to address the above-mentioned problems, the communication apparatus according to the present invention includes a receiver that receives a reception notification from a sender apparatus having at least one function not equipped by the receiver apparatus; a function information obtaining unit that accesses a server after receiving the reception notification, the server managing function information of each apparatus, and obtains the function information; a function execution unit that executes a function of the receiver apparatus; and a command unit that instructs another apparatus having a function not provided in the receiver apparatus to execute the function, during or after the execution of the current function.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a block diagram of a communication system according to an embodiment of the present invention;

FIG. 2 is an abbreviated external view of an IP telephone according to the embodiment of the present invention;

FIG. 3 is an abbreviated block diagram of the IP telephone according to the embodiment of the present invention;

FIG. 4 is an abbreviated block diagram of a home gateway (HGW) according to the embodiment of the present invention;

FIG. 5 illustrates an image of an NAPTR memory area according to the embodiment of the present invention;

FIG. 6 is a flowchart illustrating a connection operation in a communication system according to the embodiment of the present invention;

FIG. 7 illustrates the connection condition in the communication system according to the embodiment of the present invention;

FIG. 8 illustrates sequences of a display screen in the communication system according to the embodiment of the present invention;

FIG. 9 is a flowchart illustrating a connection operation in a communication system according to the second embodiment of the present invention;

FIG. 10 illustrates the connections in the communication system according to the second embodiment of the present invention;

FIG. 11 illustrates sequences of a display screen in the communication system according to the second embodiment of the present invention;

FIG. 12 is a sequence chart illustrating the communication system according to the first embodiment of the present invention; and

FIG. 13 is a sequence chart illustrating the communication system according to the second embodiment of the present invention.

### DETAILED DESCRIPTION OF PREFERRED EMBODIMENTS

The embodiments of the present invention are explained in the following, in reference to the above-described drawings. An IP telephone, as an example of the communication apparatus according to the present invention, has a voice communication function and simple display function. When receiving, from an IFAX apparatus, a signal that cannot be displayed by its own apparatus (in this case, a facsimile signal), the facsimile image can be displayed by instructing an IFAX apparatus located near the IP telephone to receive the facsimile apparatus. This is done by pre-registering and storing an NAPTR (Naming Authority Pointer) record including a telephone number having the ENUM function (e.g., a facsimile number) and function information for facsimile reception corresponding to the telephone number; inputting, from the IP telephone, the facsimile number of the IFAX apparatus located near the IP telephone; and requesting the facsimile reception function in the NAPTR record displayed in the display.

The communication apparatus (e.g., IP telephone) includes a receiver that receives an incoming call notification from a sender apparatus (e.g., IFAX), the apparatus having at least one function that is not provided in the receiver apparatus (IP telephone); a function information obtaining unit that accesses a server upon receiving the incoming call notification, the server managing function information (NAPTR record) indicating functions provided in each apparatus, and obtains the function information; a function execution unit that executes a function (e.g., voice communication function) provided in the apparatus (IP telephone); and a command unit that instructs another apparatus (e.g., IFAX) having a function not provided in the receiver apparatus (IP telephone) to execute the function during or after the execution of the current function.

The IP telephone receives, at the receiver, the incoming call notification from an outside line within the IP network, rings the reception tone, accesses the server using the function information obtaining unit, obtains the NAPTR record which is the function information managed in relation to the telephone number by the server, and displays the information on the display.

In addition, the IP telephone performs the voice communication with the IFAX (if the IFAX has the voice communication function) from the outside line, in response to the incoming call, using the function execution unit. When receiving facsimile signals, an IFAX machine near the IP telephone and the IFAX from the outside line are connected by selecting a display content (e.g., “FAX reception”) of the IFAX near the IP telephone, using the command unit. Then, the IFAX near the IP telephone and the IFAX from the outside line are connected so that the IFAX near the IP telephone can receive the facsimile signals from the outside line, in place of the IP telephone not having the FAX function.

In other words, the IP telephone has a remote control function that enables another apparatus to execute a function that is not provided within the IP telephone. Accordingly, various functions can be performed by employing other apparatuses without equipping a telephone with various types of functions.

Accordingly, the communication apparatus according to the present invention (e.g., IP telephone) includes a receiver that receives an incoming call notification from a sender apparatus (e.g., IFAX) the apparatus having at least one function that is not provided in the receiver apparatus (IP telephone); a function information obtaining unit that accesses, upon receiving the incoming call notification, a server that manages function information (NAPTR record) indicating functions provided in each apparatus and obtains the function information; a function execution unit that executes the function (voice communication function) provided in the apparatus (IP telephone); and a command unit that instructs another apparatus (IFAX) having a function not provided by the receiver apparatus (IP telephone) to execute the function during or after the execution of the current function. Therefore, the function not provided in the communication apparatus (IP telephone) can be performed using another apparatus, based on the function information, thereby easily controlling the wide variety of functions using a simple configuration.

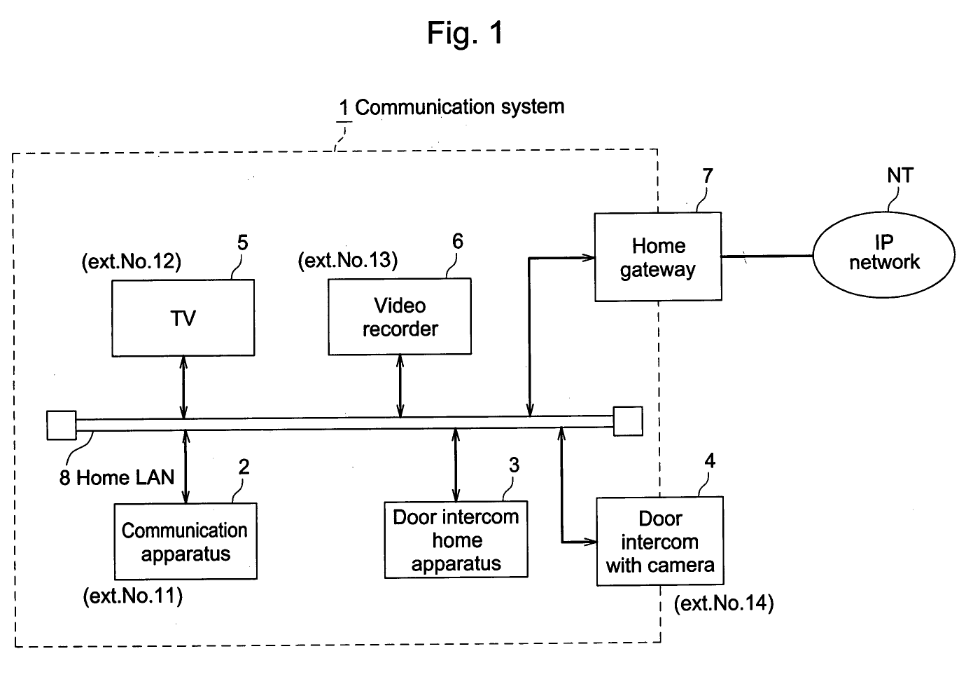

The following describes an example where the communication apparatus and communication system according to the present invention are configured in a home. FIG. 1 is a block diagram of the communication system according to the first embodiment of the present invention. In this embodiment, communication apparatus 2 (e.g., an IP telephone) answers an incoming call from door intercom with camera 4 and executes a voice communication. Since communication apparatus 2 does not have an image display function, TV 5 is instructed to display the image, when the face and appearance of the visitor need to be checked. The voice communication is executed while TV 5 displays the image. As shown in FIG. 1, communication system 1 includes and mutually connects (through LAN 8) communication apparatus 2, door intercom home apparatus 3, door intercom with camera 4, TV 5, video recorder 6, and home gateway (HGW) 7.

Door intercom home apparatus 3 and door intercom with camera 4 have IP features including transmission and reception functions as well as ordinary door intercom capabilities. In this example, door intercom home apparatus 3 is located in a living room, and door intercom with camera 4 is located at a front door.

TV 5 and video recorder 6 have IP features including transmission and reception functions as well as ordinary home appliance capabilities. In this example, TV 5 is located in a second floor bedroom together with communication apparatus 2, while video recorder 6 is located with another TV in the living room. HGW 7 is located in an unnoticeable location inside the house.

Specific home-use extension numbers “11”, “14”, “12”, and “13” are given to communication apparatus 2, door intercom with camera 4, TV 5, and video recorder 6, respectively. Such extension numbers and function information in relation to the extension numbers are pre-registered as an NAPTR record in HGW 7.

Communication apparatus 2 is configured with a normal IP telephone having a voice communication function. Communication apparatus 2 also has a role as a remote control that specifies a function of another apparatus (TV 5 or video recorder 6) so that the apparatus can be operated.

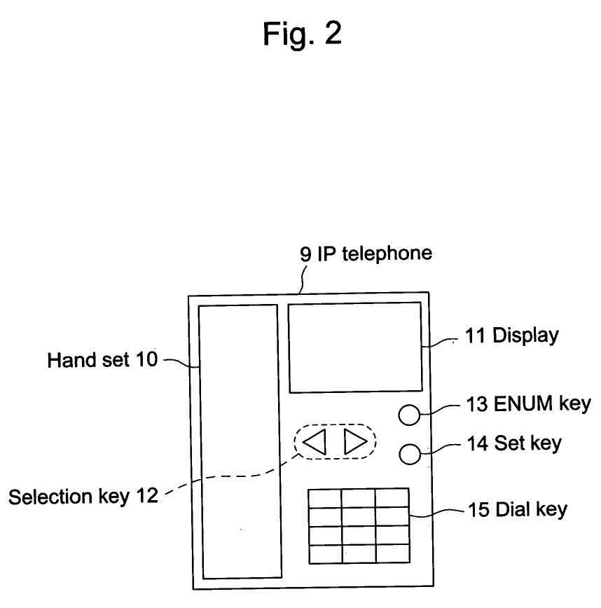

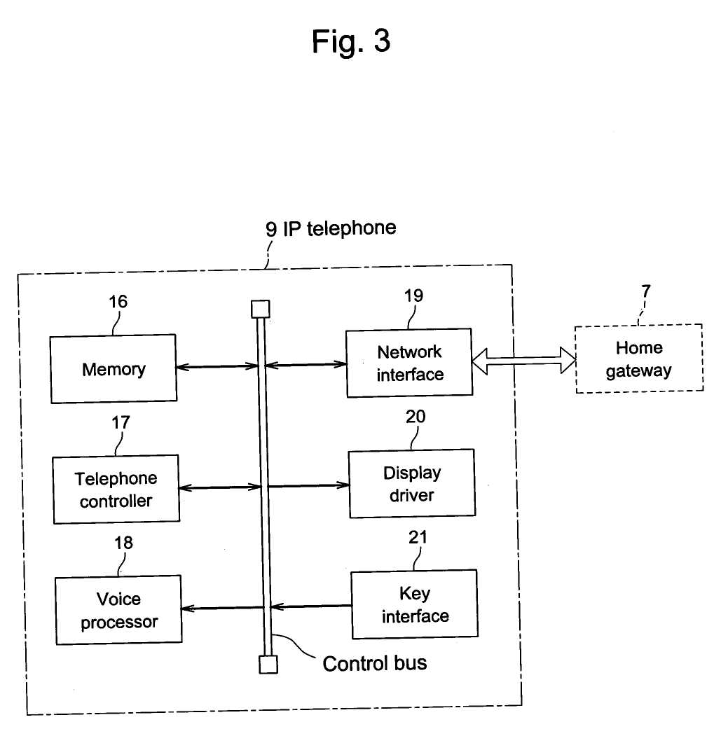

FIG. 2 is an abbreviated external view of the IP telephone according to the embodiment of the present invention. FIG. 3 is an abbreviated block diagram of the IP telephone according to the embodiment of the present invention. In FIG. 2, IP telephone 9 includes handset 10 that executes voice communications; display 11 that is configured with an LCD display element and displays an NAPTR record provided from HGW 7; selection key 12 that selects desired function information from the displayed NAPTR record; ENUM key 13 that obtains ENUM function information; set key 14 for a choosing ENUM operation from the NAPTR record function information selected by selection key 12; and dial key 15 that dials a telephone number (outside line) and an internal extension number.

As shown in FIG. 3, IP telephone 9 includes memory 16, telephone controller 17, voice processor 18, network interface 19, display driver 20, key interface 21, all of which are mutually connected via a control bus.

Memory 16 is configured with memory such as ROM and RAM. Memory 16 stores an operational programming for apparatuses and function information (NAPTR record) provided from HGW 7, and instructs display 11 to display (via display driver 20) the stored function information (NAPTR record) through a control of telephone controller 17.

Telephone controller 17 includes a microprocessor and has various operation functions, calculation functions, and control functions. Telephone controller 17 controls the entire operation of IP telephone 9.

Telephone controller 17 instructs memory 16 to store an NAPTR record provided from HGW 7, and instructs display 11 to display the NAPTR record via display driver 20.

In addition, telephone controller 17 executes a process based on key information input (provided through key interface 21) from selection key 12, EMUM key 13, set key 14, and dial key 15. The processed control information is transmitted to HGW 7 via network interface 19, so that the key information is displayed on display 11 via display driver 20.

Voice processor 18 processes a voice signal by converting an analog transmission signal into an IP signal and converting the IP signal into an analog reception signal. The voice communication is performed using handset 10.

Network interface 19 interfaces with HGW 7 to exchange key information and function information (NAPTR record), and transmits control information from telephone controller 17 to HGW 7.

Display driver 20 converts, according a control by telephone controller 17, the key information (provided from key interface 21) and the function information (NAPTR record) (provided from HGW 7 via network interface 19) into a driving signal. Then, the driving signal is given to display 11 to be displayed thereon.

Key interface 21 provides the key information (from selection key 12, EMUM key 13, set key 14, and dial key 15) to telephone controller 17.

Telephone controller 17 and network interface 19 operate as a receiver that receives an incoming call notification from a home apparatus (e.g., door intercom with camera 4), while telephone controller 17 also operates as a function information obtaining unit that obtains function information (NAPTR record). In addition, telephone controller 17 and voice processor 18 operate as a voice communication unit that executes voice communication with a home apparatus (e.g., door intercom with camera 4), while memory 16 and telephone controller 17 operate as a command unit that executes a command to forward a signal (e.g., video image) from a home apparatus (e.g., door intercom with camera 4) to another home apparatus (e.g., TV 5).

According the configuration described above, IP telephone 9 includes a receiver that receives an incoming call notification from door intercom with camera 4, the door intercom with camera 4 having a ringing function to call IP telephone 9, a voice communication function that executes voice communication with IP telephone 9 having the voice communication function, and a image capturing function that captures an object image via a camera. IP telephone 9 also includes a function information obtaining unit that accesses server (HGW 7) managing function information, after receiving the incoming call notification, and obtains the function information (NAPTR record); a voice communication unit that executes voice communication with door intercom with camera 4; and a command unit that instructs the video image to be forwarded to TV 5 during/after the voice communication, the video image being captured by door intercom with camera 4. Accordingly, communication apparatus 2 (IP telephone 9) executes the voice communication with door intercom with camera 4, and TV 5 is instructed to display the video image from door intercom with camera 4 based on the function information.

Accordingly, communication apparatus 2 according to the present invention (IP telephone 9) includes a receiver that receives an incoming call notification from a video image capturing apparatus, the apparatus having a calling function that calls a receiver apparatus (communication apparatus 2), a voice communication function that performs voice communication with the receiver apparatus having the voice communication function, and an image capturing function that captures the image through a camera. Communication apparatus 2 also includes a function information obtaining unit that accesses a server upon receiving the incoming call notification, the server managing function information, and obtains the function information; a voice communication unit that performs voice communication with the video image capturing apparatus (door intercom with camera 4); and a command unit that directs the image captured by the video image capturing apparatus to be transferred to an image viewing apparatus (TV 5) during or after the voice communication. Accordingly, the voice communication with the video image capturing apparatus is performed by the communication apparatus (IP telephone 9) and the image from the video image capturing apparatus (door intercom with camera 4) is displayed on the image display apparatus (TV 5) based on the function information (NAPTR record). Therefore, the apparatus having the desired function is controlled to expand the availability of functions in the communication system.

Door intercom home apparatus 3, which is paired with door intercom with camera 4, includes a voice communication function and an image display (monitor) function. Door intercom home apparatus 3 responds to the incoming call from door intercom with camera 4, performs voice communication with the visitor, and monitors the video image of the face and appearance of the visitor.

The direction of the incoming call from door intercom with camera 4 can be set to one of or both door intercom home apparatus 3 and communication apparatus 2. The direction may be set so that the incoming call reaches door intercom home apparatus 3 during the normal hours and communication apparatus 2 at the nighttime.

Door intercom with camera 4 includes a ringing function to call a receiver terminal (e.g., communication apparatus 2), a voice communication function that executes voice communication with the receiver terminal (e.g., communication apparatus 2) having the voice communication function, and an image capturing function that captures an object image via a camera. The ringing function, voice communication function, and image capturing function are configured with an IP interface, microphone, speaker, hand-free voice communication circuit, camera, and video signal processing circuit, in order to enable output of voice and video signals.

In addition to ordinary TV functions such as the reception function for receiving voice and image signals and generation function for generating voice and image data, TV 5 includes a transmission function for converting the voice and image signals into IP signals and transmitting them to home LAN 8. TV 5 also includes a generation function for converting the IP signals (originally voice and image signals) from home LAN 8 into normal voice and image signals and for generating voice and image data.

In addition to ordinary video recorder functions such as the video function for recording of image and voice signals and replaying the image and voice data, video recorder 6 includes a transmission function for converting the replayed voice and image signals into IP signals and for transmitting the signals to home LAN 8. Video recorder 6 also includes an image and voice recording function for converting the IP signals (originally voice and image signals) from home LAN 8 into normal voice and image signals and for recording the voice and image signals.

HGW 7 includes an NAPTR memory area that pre-registers and stores function information (NAPTR record) describing functions in relations to extension numbers of communication apparatus 2, door intercom with camera 4, control apparatus 5 and video recorder 6. When an extension number is specified from communication apparatus 2 (IP telephone 9), the function information related to the extension number is provided to communication apparatus 2 (IP telephone 9).

HGW 7 controls mutual connections between communication apparatus 2, door intercom with camera 4, TV 5, and video recorder 6. HGW 7 plays a role similar to a private branch exchange (PBX) having communication apparatus 2, door intercom with camera 4, TV 5, and video recorder 6 as internal terminals.

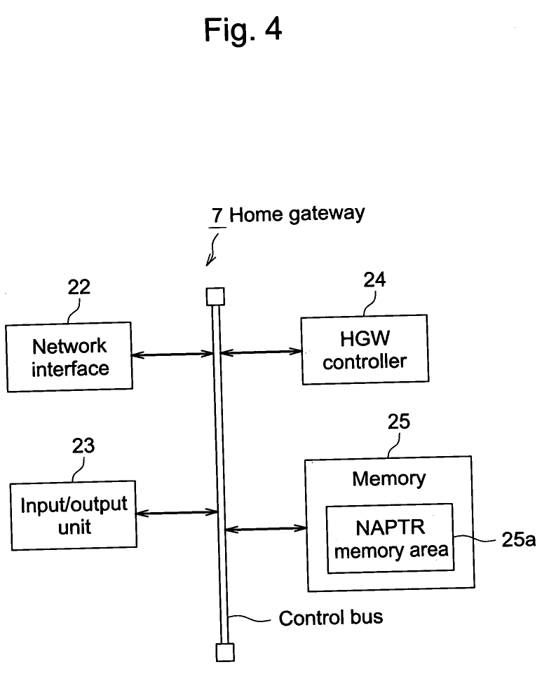

FIG. 4 is an abbreviated block diagram of the HGW according to the embodiment of the present invention. In FIG. 4, HGW 7 includes network interface 22, input/output unit 23, HGW controller 24, and memory 25, all of which are mutually connected via a control bus.

Network interface 22 interfaces with communication apparatus 2 in order to exchange control and function information (NAPTR record). When network interface 22 obtains function information (NAPTR record) from memory 25, the information is transmitted to communication apparatus 2.

HGW controller 24 controls the entire operation of HGW 7 and controls the mutual connection of door intercom with camera 4, TV 5, and video recorder 7, based on the control information (command information) transmitted from communication apparatus 2.

In addition, HGW controller 24 retrieves the function information (NAPTR record) stored in NAPTR memory area 15a of memory 25, and controls transmission to communication apparatus 2 via network interface 22.

Memory 25 is configured with ROM, RAM, and other memory. Memory 25 includes NAPTR memory area 15a.

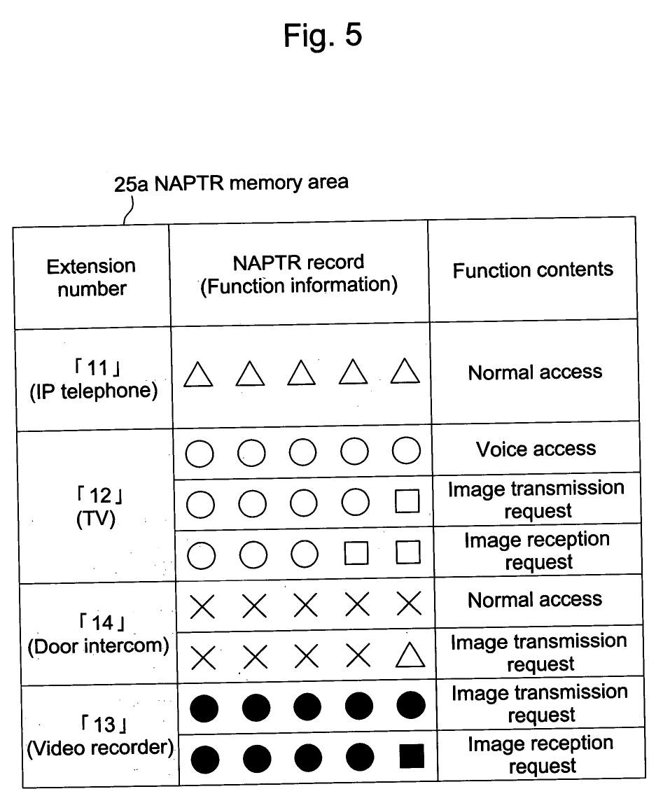

FIG. 5 illustrates an image of the NAPTR memory area according to the embodiment of the present invention. As shown in FIG. 5, NAPTR memory area 15a stores an NAPTR record (function information) of extension numbers “11”, “14”, “12”, and “13” that are respectively used for communication apparatus 2 (IP telephone 9), door intercom with camera 4, TV 5, and video recorder 6.

For example, NAPTR record “ΔΔΔΔΔ” (normal access) is stored for extension number “11” (for IP telephone). NAPTR record “◯◯◯◯◯” (voice access), NAPTR record “◯◯◯◯□” (image transmission request), and NAPTR record “◯◯◯□□” (image reception request) are stored for extension number “12” (for TV).

The following describes the connection operation of the communication system according to the embodiment of the present invention, using drawings for connection steps, connection condition, and display screen sequences. The connection operation of the communication system is explained using two examples of displaying a video image on nearby TV 5 from IP telephone 9, the image being captured from door intercom with camera 4.

First, communication apparatus 2 transmits to TV 5 a command to receive the video image. Then, communication apparatus 2 transmits to door intercom with camera 4 a command to transmit the video image. Accordingly, the video image that cannot be received by communication apparatus 2 can be displayed on TV 5 by instructing door intercom with camera 4 to transmit the image to TV 5.

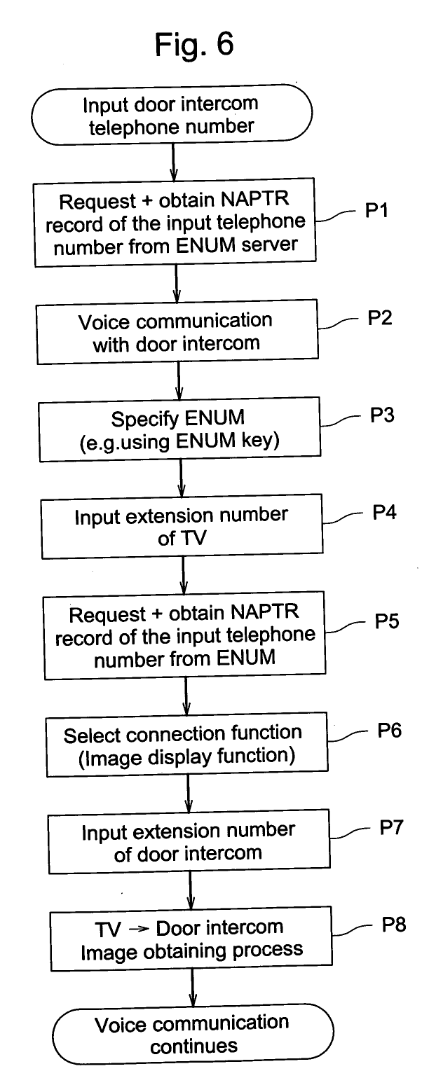

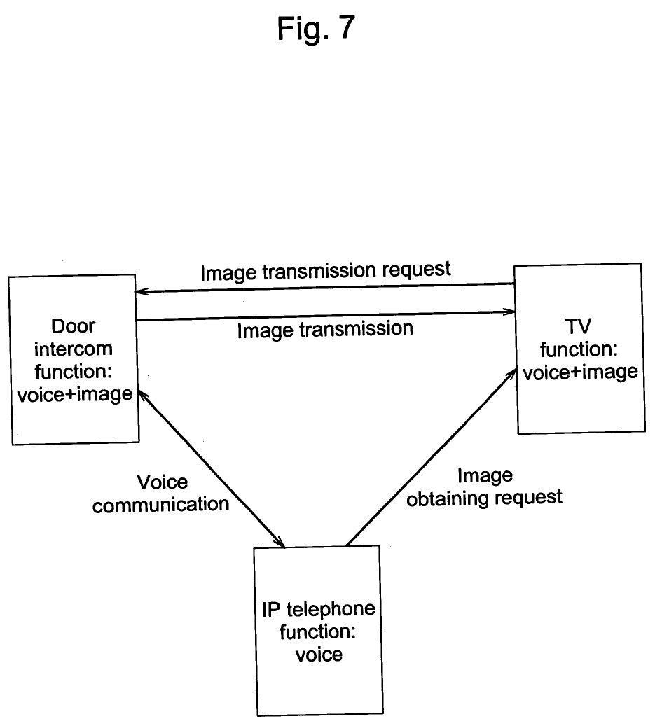

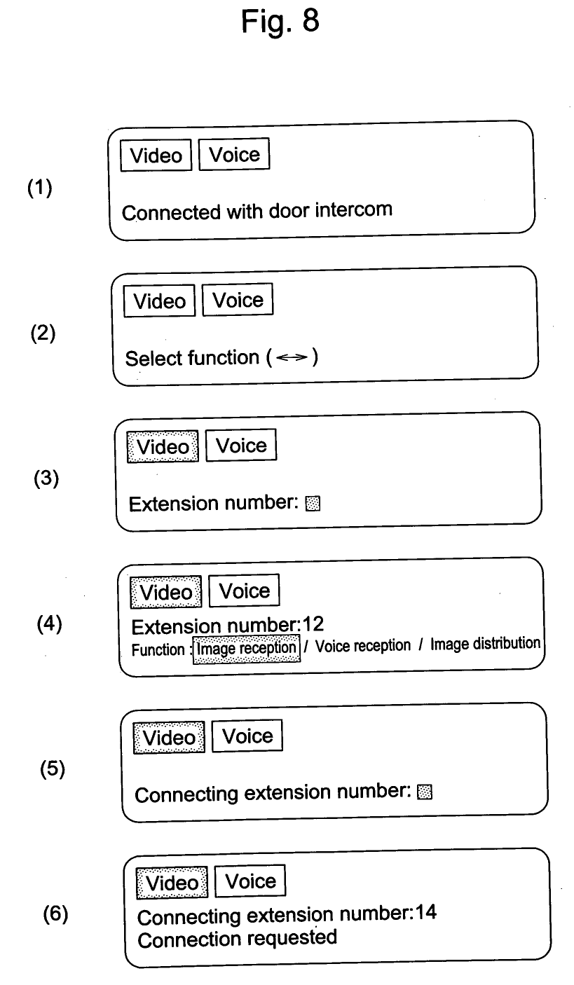

FIG. 6 is a flowchart illustrating a connection operation in the communication system according to the embodiment of the present invention. FIG. 7 illustrates the connection condition in the communication system according to the embodiment of the present invention. FIG. 8 illustrates sequences of a display screen in the communication system according to the embodiment of the present invention.

As shown in FIG. 6, at step P1, an NAPTR record of the input telephone number is requested and obtained from the ENUM server (HGW 7).

At step P2, door intercom with camera 4 and IP telephone 9 perform voice communication. At step P3, ENUM key 13 of IP telephone 9 is operated to request the ENUM operation.

At step P4, extension number “12” of TV 5 is entered from IP telephone 9. At step P5, the NAPTR record of the input telephone number (extension number “12”) is requested and obtained from the ENUM server (HGW 7).

At step P6, a connection function (image reception request) displayed on the display screen of IP telephone 9 is selected. At step P7, extension number “14” of the door intercom with camera 4 is input.

At step P8, the NAPTR record of the input telephone number (extension number “14”) is requested and obtained from the ENUM server (HGW 7). After selecting a connection function (image transmission request), TV 5 performs an image obtaining process to obtain the image from door intercom with camera 4 and displays the image on the display, the image being captured by door intercom with camera 4.

As shown in FIG. 7, door intercom with camera 4 initially calls IP telephone 9 in order for IP telephone 9 and door intercom with camera 4 to be in a voice communication state. Next, IP telephone 9 selects the NAPTR record of TV 5 and transmits an image obtaining request to TV 5.

Then, IP telephone 9 transmits a command to instruct TV 5 to transmit the image transmission request to door intercom with camera 4. When door intercom with camera 4 transmits the image to TV 5, the image is displayed on the screen of TV 5.

In FIG. 8, IP telephone 9 and door intercom with camera 4 are connected and in the voice communication state (display 1)). When selection key 12 is operated, “Video” function is selected (displays 2) and 3)).

When extension number “12” of TV 5 is input, NAPTR record functions of extension number “12” (image reception, voice reception, image distribution) are displayed. In this example, “image reception” is selected from selection key 12 (display 4)).

Next, an input of a connecting extension number is prompted (display 5)). When extension number “14” is input, the connection to door intercom with camera 4 is requested (display 6)).

Accordingly, communication system 1 according to the present invention includes a video image capturing apparatus that has a calling function that calls communication apparatus 2, a voice communication function that performs voice communication with the communication apparatus 2, and an image capturing function that captures an image through a camera. Communication system 1 also includes communication apparatus 2 (e.g., IP telephone) that performs voice communication with the video image capturing apparatus; an image display apparatus (e.g., TV 5) that displays the video image captured by the video image capturing apparatus (door intercom with camera 4) according to the instruction from communication apparatus 2; a server (e.g., HGW 7) that manages function information (NAPTR record) of image display apparatus 5, video image capturing apparatus 4, and communication apparatus 2. All of the components in communication system 1 are connected through LAN. Communication apparatus 2 performs the voice communication upon receiving the call from video image capturing apparatus 4 and instructs image display apparatus 5 to display the video image. Video image capturing apparatus 4 transmits the captured video image to image display apparatus 5 according to the transmission request from image display apparatus 5. Therefore, only selecting a function from communication apparatus 2(IP telephone 9) and inputting the extension numbers of image display apparatus 5 and video image capturing apparatus 4 will instruct the image display apparatus (TV 5) to display the video image from the video image capturing apparatus (door intercom with camera 4). Thus, the video image display function that is not provided in communication apparatus 2 is performed by the image display apparatus (TV 5), thereby increasing the available functions and improving the convenience of the use of the communication system with a simple operation.

In the next embodiment, communication apparatus 2 transmits a video image transmission request to door intercom with camera 4. Then, door intercom with camera 4 transmits an image reception request and transmits the video image to TV 5. Therefore, the image that cannot be received by communication apparatus 2 can be displayed on TV 5.

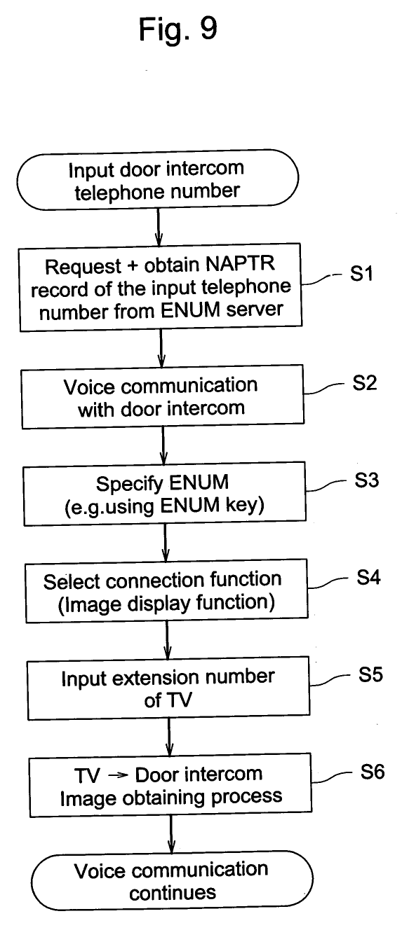

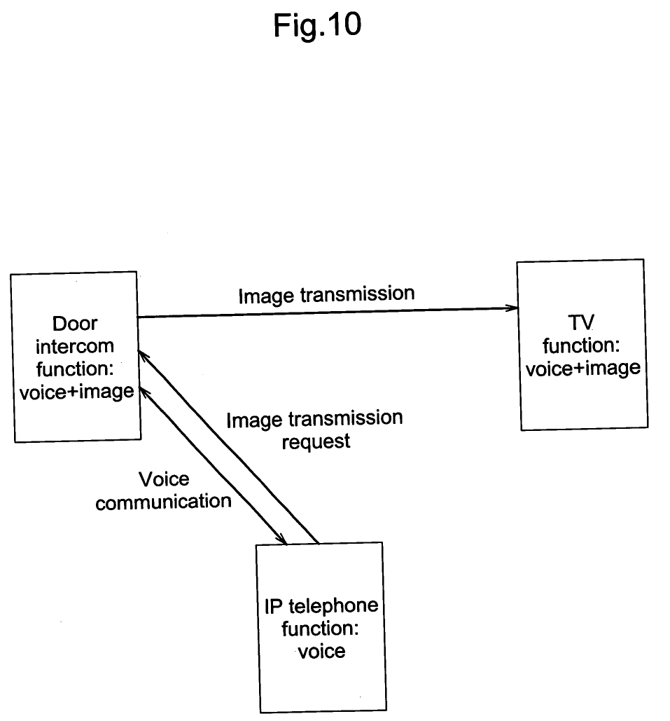

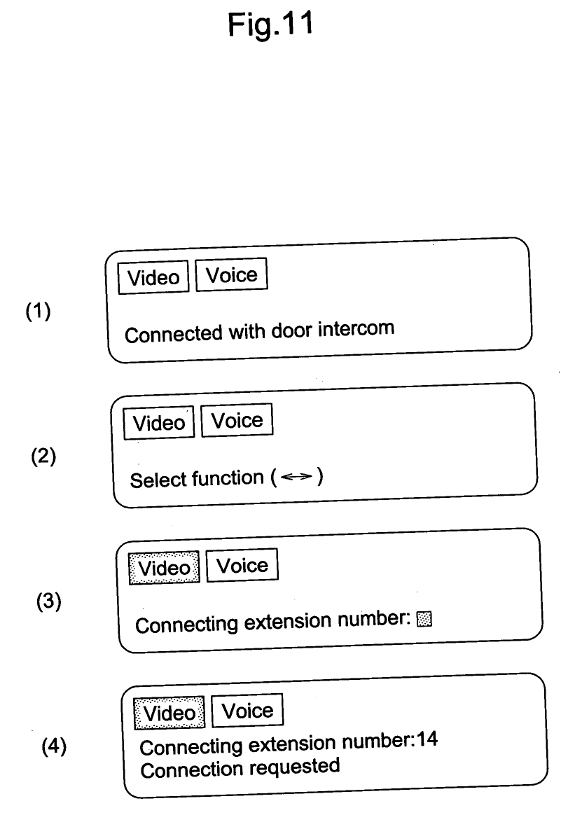

FIG. 9 is a flowchart illustrating a connection operation in a communication system according to the second embodiment of the present invention. FIG. 10 illustrates the connections in the communication system according to the second embodiment of the present invention. FIG. 11 illustrates sequences of a display screen in the communication system according to the second embodiment of the present invention.

As shown in FIG. 9, at step S1, an NAPTR record of the input telephone number is requested and obtained from the ENUM server (HGW 7).

At step S2, door intercom with camera 4 and IP telephone 9 perform voice communication. At step S3, ENUM key 13 of IP telephone 9 is operated to request the ENUM operation.

At step S4, IP telephone 9 selects a connection function (image transmission request) that is displayed on the display screen of door intercom with camera 4. At step S5, extension number “12” of TV 5 is entered from IP telephone 9.

At step S6, the NAPTR record of the input telephone number (extension number “12”) is requested and obtained from the ENUM server (HGW 7). After selecting the connection function (image reception request) displayed on the display screen, door intercom with camera 4 performs the image obtaining process on TV 5 in order to display on the display of TV 5 the image captured by door intercom with camera 4.

As shown in FIG. 10, door intercom with camera 4 initially calls IP telephone 9 in order for IP telephone 9 and door intercom with camera 4 to be in a voice communication state. Next, IP telephone 9 transmits an image transmission request to door intercom with camera 4.

Then, door intercom with camera 4 transmits an image reception request to TV 5 so that the image is transmitted form door intercom with camera 4 to TV 5 and displayed on the screen of TV 5.

In FIG. 11, IP telephone 9 and door intercom with camera 4 are connected and in the voice communication state (display 1)). When selection key 12 is operated, “Video” function is selected (displays 2) and 3)). At this stage, an input of the connecting extension number is prompted. Therefore, extension number “14” is input and the connection is requested (display 4)).

Accordingly, communication system 1 according to the present invention includes a video image capturing apparatus (e.g., door intercom with camera 4) that has a calling function that calls communication apparatus 2, a voice communication function that performs voice communication with the communication apparatus 2, and an image capturing function that captures video images through a camera. Communication system 1 also includes communication apparatus 2 (e.g., IP telephone 9) that performs voice communication with the video image capturing apparatus; an image display apparatus (e.g., TV 5) that displays the video image captured by the video image capturing apparatus (door intercom with camera 4) according to the instruction from communication apparatus 2; and a server that manages function information (NAPTR record) of image display apparatus 5, video image capturing apparatus 4, and communication apparatus 2. All of the components in communication system 1 are connected through LAN. Communication apparatus 2 performs the voice communication upon receiving the call from video image capturing apparatus 2 and instructs video image capturing apparatus 4 to display the video image on image display apparatus 5. Video image capturing apparatus 4 obtains address information of image display apparatus 5 and transmits the captured video image to image display apparatus 5 using the obtained address. Therefore, only selecting a function from communication apparatus 2 and inputting the extension number of video image capturing apparatus 4 will instruct image display apparatus 5 to display the video image from video image capturing apparatus 4. Thus, the video image display function that is not provided in the communication apparatus is performed by the image display apparatus, thereby increasing the available functions and improving the convenience of the use of the communication system with a simple operation.

In addition, the server according to the present invention is a ENUM server installed in HGW 7. Therefore, by storing NAPTR records having functions in relation to extension numbers in NAPTR memory area 25a and by specifying one of the records, it is possible to perform a desired function and increase the available functions while improving the convenience of the use of the communication system with a simple operation.

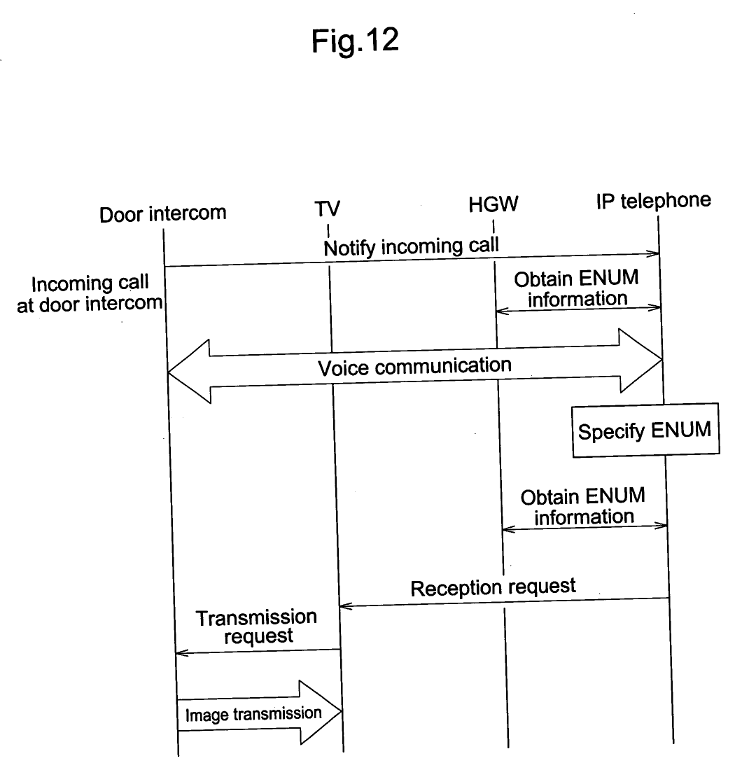

FIG. 12 is a sequence chart illustrating the communication system according to the first embodiment of the present invention. FIG. 12 relates to FIGS. 6-8. When receiving a call from a visitor through door intercom with camera 4, an incoming call notification is transmitted to IP telephone 9. When IP telephone 9 obtains ENUM information from HGW 7, door intercom with camera 4 and IP telephone 9 can perform voice communication.

Since IP telephone 9 does not have the image display function, IP telephone 9 instructs HGW 7 to perform an ENUM operation and obtains ENUM information from HGW 7.

Then, IP telephone 9 transmits an image reception request to TV 5. When TV 5 transmits an image transmission request to door intercom with camera 4, door intercom with camera 4 transmits a video image signal to TV 5 so that TV 5 can display the image.

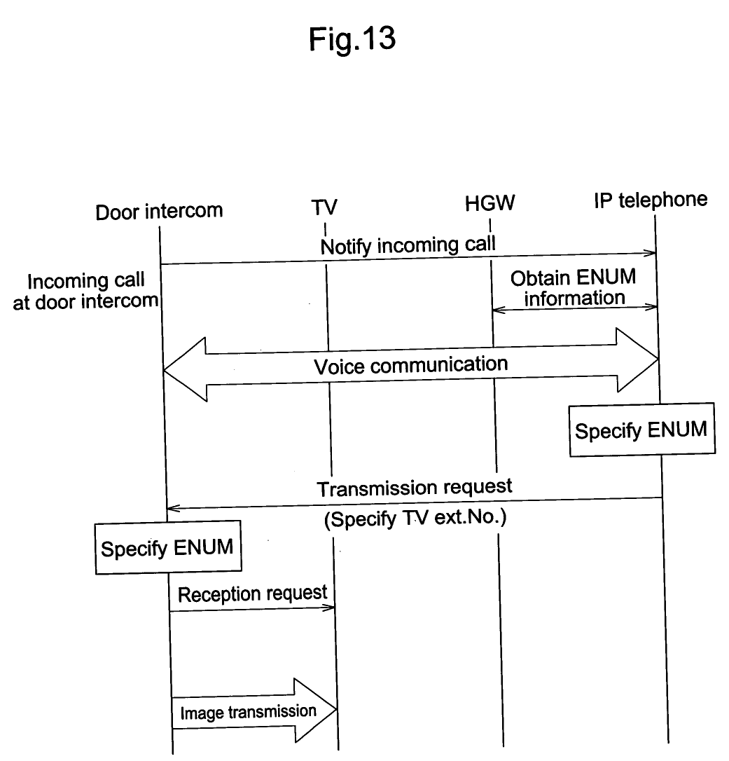

FIG. 13 is a sequence chart illustrating the communication system according to the second embodiment of the present invention. FIG. 13 relates to FIGS. 9-11. When receiving a call from a visitor through door intercom with camera 4, an incoming call notification is transmitted to IP telephone 9. When IP telephone 9 obtains ENUM information from HGW 7, door intercom with camera 4 and IP telephone 9 can perform voice communication.

Since IP telephone 9 does not have the image display function, IP telephone 9 specifies an ENUM operation and transmits an image transmission request to door intercom with camera 4.

Then, door intercom with camera 4 performs ENUM operation. After door intercom with camera 4 transmits an image reception request to TV 5, door intercom with camera 4 transmits a video image signal to TV 5 so that TV 5 can display the image.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2003-433358 filed on Dec. 26, 2003, entire content of which is expressly incorporated by reference herein.

1. A communication apparatus connected to a server via a network, the server storing function information of each of a plurality of communication apparatuses, the communication apparatus comprising:
a receiver that receives a reception notification from a sender apparatus;
a function information obtaining unit that accesses the server after receiving the reception notification to obtain the function information of the sender apparatus;
a function execution unit that executes a function of the communication apparatus; and
a command unit that instructs another apparatus having a function not provided in the communication apparatus to execute the function, during or after the execution of the current function.

2. The communication apparatus according to claim 1, wherein the sender that transmits the reception notification has at least one function not equipped by the communication apparatus.

3. The communication apparatus according to claim 1, further comprising a operational panel configured to input information of an apparatus which is different from the communication apparatus, wherein said function information obtaining unit accesses the server to obtain the function information of the apparatus whose information is inputted from said operational panel.

4. The communication apparatus according to claim 1, wherein the communication apparatus comprises an Internet Protocol telephone machine.

5. The communication apparatus according to claim 4, wherein the sender comprises an Internet facsimile apparatus, and the apparatus whose information is inputted from said operational panel is an Internet facsimile apparatus.

6. A communication apparatus connected to a server via a network, the server storing function information of each of a plurality of apparatuses, the communication apparatus comprising:
a receiver that receives an incoming call notification from a video image capturing apparatus, the video image capturing apparatus having a calling function that calls the communication apparatus, a voice communication function that performs voice communication with the communication apparatus, and an image capturing function that captures an image through a camera;
a function information obtaining unit that accesses a server upon receiving the incoming call notification to obtain the function information of the video image capturing apparatus;
a voice communication unit that performs voice communication with the video image capturing apparatus; and
a command unit that directs an image captured by the video image capturing apparatus to be transferred to an image viewing apparatus during or after the voice communication, the image viewing apparatus connecting to the communication apparatus via the network.

7. The communication apparatus according to claim 6, wherein the communication apparatus comprises an Internet Protocol telephone machine.

8. The communication apparatus according to claim 7, wherein the video image capturing apparatus comprises a door intercom, and the image viewing apparatus comprises a television apparatus.

9. The communication apparatus according to claim 6, further comprising a operational panel configured to input information of the image viewing apparatus, wherein said function information obtaining unit accesses the server to obtain the function information of the image viewing apparatus, whereby the image viewing apparatus is able to obtain the image captured by the video image capturing apparatus.

10. The communication apparatus according to claim 6, wherein the server comprises an ENUM server installed in a home gateway apparatus.

11. A method for communicating from a sender to a communication apparatus, the communication apparatus not having a function the sender requires the communication apparatus to perform, the communication apparatus connecting to a server that stores function information of each of a plurality of communication apparatuses, the method comprising:
receiving a reception notification from the sender apparatus;
accessing the server after receiving the reception notification to obtain the function information of the sender apparatus;
executing a function of the communication apparatus; and
instructing another apparatus having a function not provided in the communication apparatus to execute the function, during or after the execution of the current function.

12. The method according to claim 11, further comprising:
inputting information of an apparatus which is different from the communication apparatus;
accessing the server to obtain the function information of the apparatus whose information is inputted, whereby data is transferred to the apparatus to execute the function of the apparatus.

13. The method according to claim 11, wherein the communication apparatus comprises an Internet Protocol telephone machine.

14. The method according to claim 13, wherein the sender comprises an Internet facsimile apparatus, and the apparatus whose information is inputted is an Internet facsimile apparatus.

15. A method for communicating from a video image capturing apparatus to a communication apparatus, the communication apparatus not having a function the sender requires the communication apparatus to perform, the communication apparatus connecting to a server that stores function information of each of a plurality of communication apparatuses, the method comprising:
receiving an incoming call notification from a video image capturing apparatus, the video image capturing apparatus having a calling function that calls the communication apparatus, a voice communication function that performs voice communication with the communication apparatus, and an image capturing function that captures an image through a camera;
accessing a server upon receiving the incoming call notification to obtain the function information of the video image capturing apparatus;
performing voice communication with the video image capturing apparatus; and
directing an image captured by the video image capturing apparatus to be transferred to an image viewing apparatus during or after the voice communication, the image viewing apparatus connecting to the communication apparatus via the network.

16. The method according to claim 15, wherein the communication apparatus comprises an Internet Protocol telephone machine.

17. The method according to claim 16, wherein the video image capturing apparatus comprises a door intercom, and the image viewing apparatus comprises a television apparatus.

18. The method according to claim 15, further comprising:
inputting information of the image viewing apparatus;
accessing the server to obtain the function information of the image viewing apparatus, whereby the image viewing apparatus is able to obtain the image captured by the video image capturing apparatus.
